(19) United States
(12) Patent Application Publication
(10) Pub. No.: US 2010/0033017 A1
(43) Pub. Date: Feb. 11, 2010

(54) ELECTRONIC DEVICE

(76) Inventor: Tzu-Chieh HUANG, Taipei (TW)

Correspondence Address: BIRCH STEWART KOLASCH & BIRCH, PO BOX 747, FALLS CHURCH, VA, 22040-0747, US

(21) Appl. No.: 12/412,654

(22) Filed: Mar. 27, 2009

(30) Foreign Application Priority Data
Aug. 8, 2008 (TW) 097130357

(51) Int. Cl. H02J 1/00

(52) U.S. Cl. 307/80

(57) ABSTRACT

A holding device with charging function includes a holder, a solar power receiving module and a power transformer. The holder is provided for holding an electronic device. The solar power receiving module is coupled with the holder and electrically coupled to the power transformer. The solar power receiving module receives and transforms solar power to a first power source, and the power transformer has an external input port for electrically coupling to an external second power source. The power transformer selectively conducts the first power source and the second power source and transforms the conducted power source to an output voltage.

This application claims priority based on a Taiwanese patent application No. 097130357, filed Aug. 8, 2008, the disclosure of which is incorporated herein by reference in its entirety.

### BACKGROUND OF THE INVENTION

1. Field of the Invention

This invention relates generally to a holding device. More particularly, this invention relates to a holding device with charging function for holding an electronic device.

2. Description of the Prior Art

Being multi-functional and slim are important considerations of consuming electronic products, especially portable electronic devices such as cell phones, personal digital assistants, digital cameras, and global positioning system navigators. It is inconvenient to the driver that be cannot hold the electronic device when he is driving the car. Therefore, a holding device for fixing or holding the electronic device in the car is needed. Besides, to achieve a high mobility, the power of the portable electronic device is provided by a battery, such as a disposable battery or a rechargeable battery. However, the portable electronic device is not functional, which bothers the user, when running out of the battery capacity since the battery capacity is limited. Although the portable electronic device is often equipped with a charger, the charger usually needs to plug in an outlet to charge the portable electronic device. Therefore, the charging and the power capacity of the portable electronic device, for example used in a car, are both improvable.

### SUMMARY OF THE INVENTION

It is an object of the present invention to provide an electronic device with charging function for connecting an electronic device with an object.

It is another object of the present invention to provide a holding device with charging function for providing a different power source to the electronic device to achieve better charging effect.

The holding device with charging function of the present invention includes a holder, a solar power receiving module and a power transformer. The holder is provided for holding an electronic device. The solar power receiving module is coupled with the holder and electrically coupled to the power transformer. The solar power receiving module receives and transforms solar power to a first power source, and the power transformer has an external input port for electrically coupling to an external second power source. In a preferred embodiment, the power transformer includes a detecting circuit and a switch; the detecting circuit detects the status of the first power source and the second power source to output a controlling signal to the switch and selectively conducts the first power source and the second power source and transforms the conducted power source to an output voltage.

### BRIEF DESCRIPTION OF THE DRAWINGS

FIG. 1 illustrates a perspective view of an embodiment of the holding device with charging function of the present invention;

FIG. 2A shows a side view of an embodiment of the holding device with charging function of the present invention;

FIG. 2B shows a side view of another embodiment of the holding device with charging function of the present invention;

FIG. 3 shows a schematic view of the circuit block diagram of an embodiment of the holding device with charging function of the present invention;

FIG. 4A illustrates a circuit block diagram of an embodiment of the holding device with charging function of the present invention;

FIG. 4B shows a circuit block diagram of an embodiment of the power transformer of the present invention;

FIG. 4C shows a circuit diagram of an embodiment of the detecting circuit of the present invention;

FIG. 5A shows a circuit block diagram of another embodiment of the holding device with charging function of the present invention;

FIG. 5B shows a circuit block diagram of another embodiment of the power transformer of the present invention; and

FIG. 6 shows a circuit block diagram of another embodiment of the holding device with charging function of the present invention;

### DETAILED DESCRIPTION OF THE PREFERRED EMBODIMENT

To solve the above improvable problems, a holding device with charging function is provided in the present invention. In the preferred embodiment, the holding device with charging function is connected with an object, such as the windows, in a car for holding an electronic device and provides the electronic device a power source. In the preferred embodiment, the electronic device is a global positioning system navigators (or a electronic device having global positioning function). In other embodiments, however, the electronic device includes a mobile phone, a laptop or other portable electronic device needs to be charged.

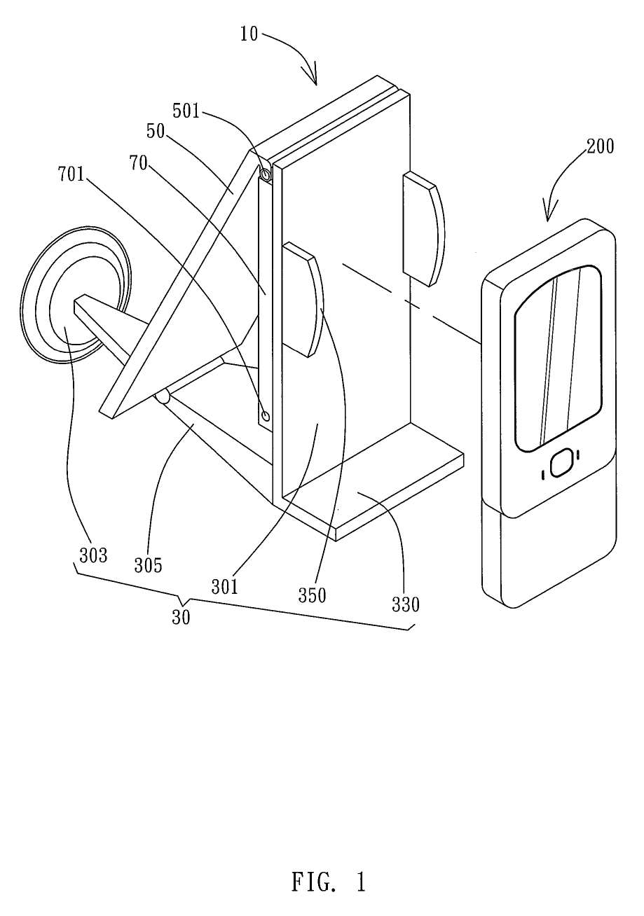

FIG. 1 is a perspective view of an embodiment of the holding device 10 with charging function and an electronic device 200 of the present invention. As shown in this figure, the holding device 10 of the present invention includes a holder 30, a solar power receiving module 50 and a power transformer 70. The holder has a clamping part, a connecting part 301 and a rotation arm 305 and receives the electronic device 200. The clamping part 303 clamps the electronic device 200. The connecting part 303 connects to an object. The rotation arm 305 is disposed between and connects the clamping part 301 and the connecting part 303, wherein the rotation arm 305 has a pivot for rotatably adjusting the relative position of the clamping part 301 and the connecting part 303. The connecting part 303 connects the holding device to the object. For example, the connecting part 303 is preferably a plastic sucking disk which is able to suck on a plan surface of some material such as window glass. However, in other embodiments, the connecting part could be other unit with different structures, such as a clasp or a dip etc., to hook on other objects such as the handles of a bike or a motorcycle. Please refer to FIG. 1, the holder 30 in this embodiment has a tray 330 and two arms 350 corresponding to each other. The arms 350 and the extending direction of the tray 330 are substantially perpendicular to each other, wherein the two arms 350 and the tray 330 surround to form a space for receiving the electronic device 200. More particularly, the tray 330 carries the bottom face of the electronic device 200, wherein the corresponding two arms 350 press close to the two side face of the electronic device 200 perpendicular to the bottom face. Therefore, the electronic device 200 is not only fixed but also prevented from falling out of the holder 30.

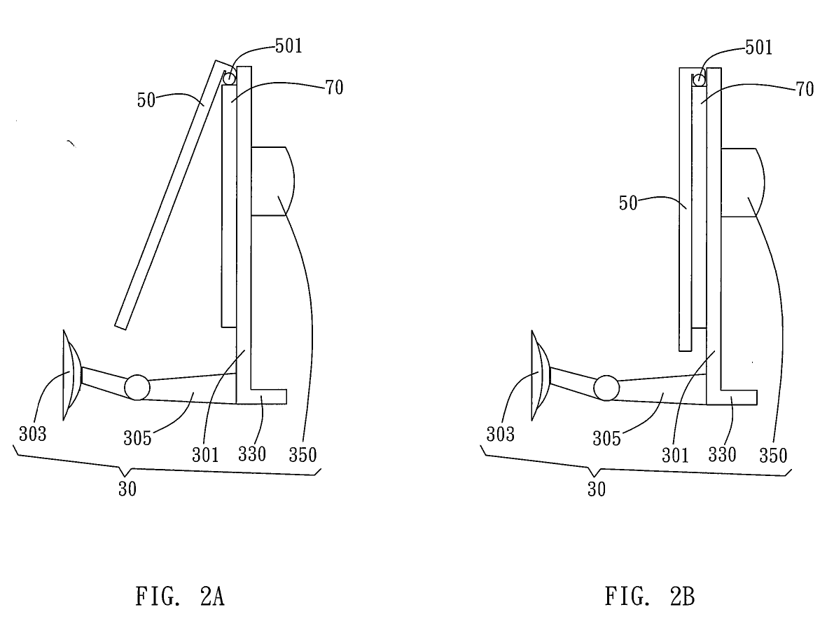

FIG. 2A and FIG. 2B are side views of an embodiment of the holding device 10 with charging function of the present invention. FIG. 2A and FIG. 2B respectively show the different angle included by the solar power receiving module 50 and the holder 30. The solar power receiving module 50 of the holding device 10 is disposed on the holder 30. More particularly, the solar power receiving part 50 of this embodiment has a rotation pivot 501 connected to one end or other position of the holder 30 for rotatably adjusting the angle of the solar power receiving module 50 relative to the holder 30.

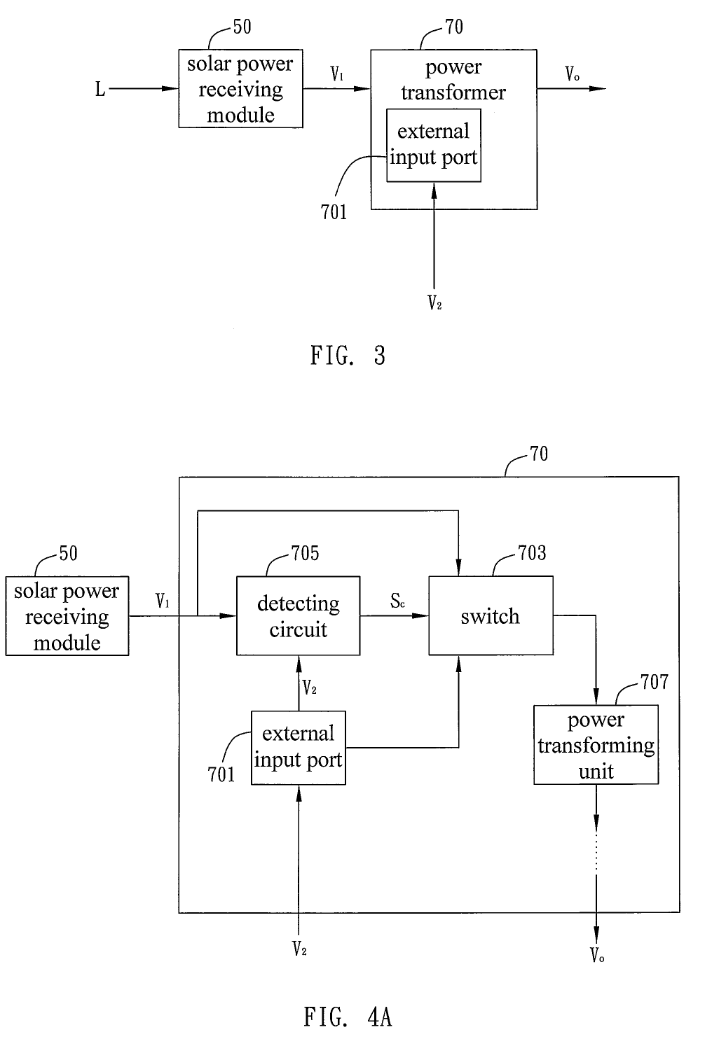

FIG. 3 further shows the circuit structure and the signal transferring between the elements of the holding device 10 of the present invention by a circuit block diagram. The solar power receiving module 50 of the holding device 10 receives the exterior solar power L and transforms the solar power L to a first power source V1. The solar power receiving module 50 electronically couples the power transformer 70 to input the first power source V1 into the power transformer 70. Besides, the power transformer 70 has an external input port 701 being able to electrically couples to a second power source V2, wherein the second power source V2 could be a car power supply or other external power. The power transformer 70 receives the first power source V1 and the second power source V2 to proceed a particular circuit processing or a digital calculation inside and selectively transforms one of the first power source V1 and the second power source V2 to an output voltage V0 of the power transformer 70.

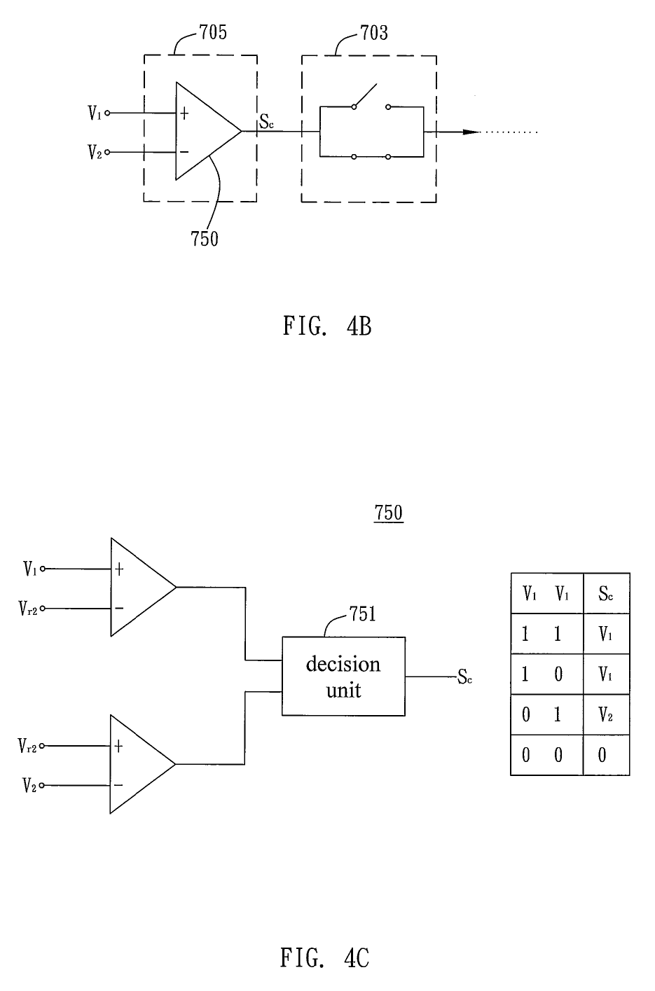

FIG. 4A is a circuit block diagram of another embodiment of the holding device 10 of the present invention. With reference to the figure, the power transformer 70 further includes a switch 703, a detecting circuit 705 and a power transforming unit 707. The first power source V1 provided by the solar power receiving module 50 and the second power source V2 provided by the external input port 701 both electronically couple to the switch 703, wherein the switch 703 selectively conducts to one of the first power source V1 and the second power source V2. The detecting circuit 705 electrically couples to the switch 703, the first power source V1 and the second power source V2 for detecting voltage levels of the first power source V1 and the second power source V2. The detecting circuit 705 outputs a controlling signal Sc in accordance with a determination of a proper power source, either the first power source V1 or the second power source V2, by process some predetermined calculation method based on the voltage levels. The proper power source refers to a power source with higher or more stable voltage. However, in a particular embodiment, since the first power source V1 includes a power source transformed from the solar power received by the solar power receiving module, the first power source V1 could be defined as a preferred power source. Therefore, the detecting circuit determines the first power source V1 as the proper power source when the value of the first power source V1 is larger than a critical value in accordance with the calculating method. The controlling signal Sc inputs into the switch to induce the switch selectively conducting the first power source or the second power source. The above predetermined calculation method could have different ways to carry out in different embodiments described below. The power transformer 70 further has a power transformer unit 707 transforming the power source, i.e. the first power source V1 or the second power source V2, to an acceptable set potential of the electronic device 200. The first power source and the second power source in the embodiments could include different kinds of powers, such as alternating current, alternating potential, direct current and direct potential. In other embodiments, the design of the power transforming unit could be changed. For example, the power transforming unit might has a potential amplify circuit or a current-to-potential transforming circuit. Moreover, in other embodiments under the circumstances that the potential design of the first power source or the second power source fits in with the range of the set potential of the connected electronic device, the power transforming unit could be excluded from the power transformer.

FIG. 4B shows the switch 703 and the detecting circuit 705 circuit of the power transformer 70 of an embodiment of the present invention. As shown in FIG. 4B, the switch 703 has an output end and an input end, the input end selectively connects to the first power source V1 and the second power source V2. When the switch 703 is open in the path connecting these power sources, i.e. the first power source V1 and the second power source V2, it indicates that these power sources haven't been conducted yet. When the switch 703 is close in the path connecting these power sources, i.e. the first power source V1 and the second power source V2, it indicates that these power source are conducted to the output end. FIG. 4B shows a conducting state of the present embodiment, wherein the path of the second power source V2 is close. The switch 703 could be a conventional diode, a transistor or other well known circuit switch, wherein the application of different types of circuit switch doesn't restrain the scope of the present invention.

Moreover, the detecting circuit 705 includes a comparing unit 750 which may be a regular amplifier, such as a differential amplifier, for example. Two input ends of the comparing unit 750 are respectively connects to the first power source V1 and the second power source V2. The output end of the comparing unit 750 obtains a corresponding comparing result in accordance with the values of the two input ends. The detecting circuit 750 produces a corresponding controlling signal Sc in accordance with the comparing result. In other words, the comparing unit 750 compares the magnitude of the two input ends, i.e. the magnitude of the two power source. The produced controlling signal Sc inputs into the circuit of the switch 703 to control the switch 703 conducting the first power source V1 if the comparing result indicate the first power source is larger than the second power source. Please note that FIG. 4B is a simplified circuit diagram. The switch 703 and the detecting circuit 705 of the power transformer 70 of the embodiment of the present also include other electronic unit to construct a complete electronic circuit.

In other embodiment shown in FIG. 4C, the comparing unit 750 includes more than one comparing unit. The first power source V1 and the second power source V2 respectively inputs into two different comparing units. The other ends of these comparing units are respectively a first reference power source Vr1 and a second reference power source Vr2. The first power source V1 and the first reference power source Vr1 are input into the same comparing unit to obtain a comparing result while the second power source V2 and the second reference power source are input into another comparing unit to obtain another comparing result. These two comparing results are then input into the decision unit 751 to obtain the final comparing result, wherein the detecting circuit obtains the controlling signal Sc to control the switch in accordance with the final comparing result. In a word, the circuit of this embodiment first decides whether the first power source V1 and the second power source are larger than a predetermined reference power source value, and then determines the final output of the decision unit 751. The decision unit 751 could be formed by logic calculation units, such as a OR gate, wherein the logic result is defined as shown in FIG. 4C. For example, if the comparing unit 750 determines that the first power source V1 and the second power source V2 are both larger than the reference power sources, the decision unit 751 formed by the OR gate outputs the controlling signal Sc to induces the switch 703 conducting the first power source V1. However, the comparing unit and the decision unit could be different types or other structures, the logic result of the OR gate could also be varied in different designs. The above embodiments do not restrain the scope of the present invention.

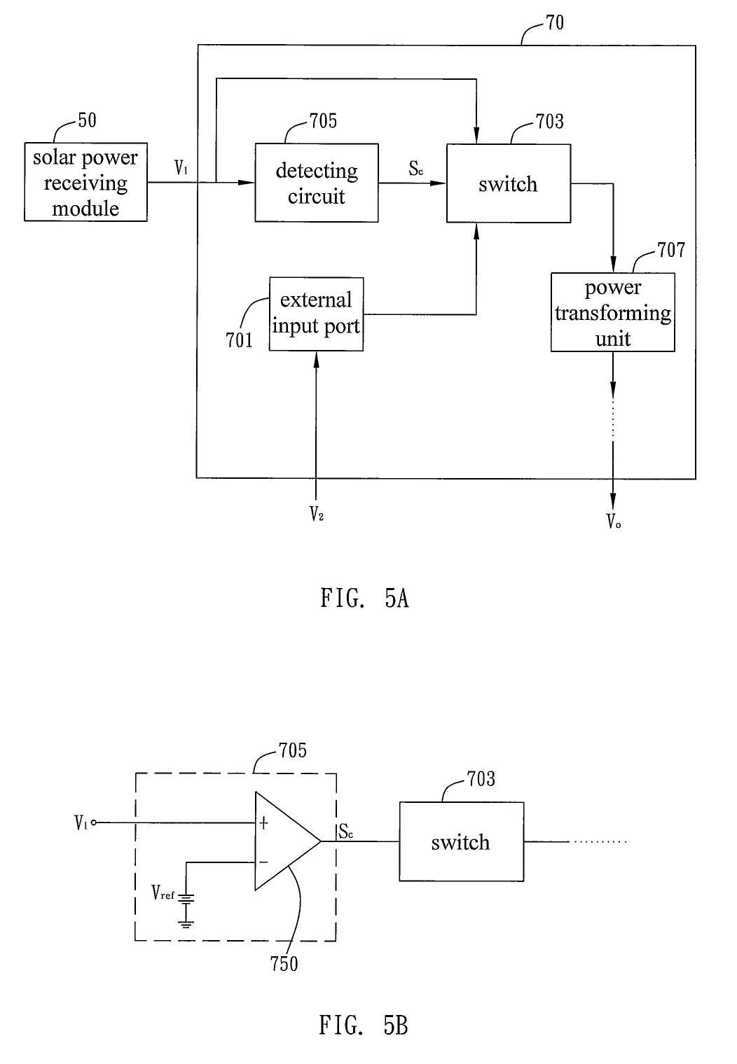

FIG. 5A shows another embodiment circuit diagram of a power transformer 70. The detecting circuit 705 of the power transformer 70 electronically couples to the switch 703 and the first power source V1, rather than couples to the second power source V2. The detecting circuit 705 connects to a reference power source V_{ref}, wherein the detecting circuit 705 further determines the alternative connection to the first power source V1 or the second power source V2 in accordance with the values of the first power source V1 and the reference power source V_{ref}. With reference to FIG. 5B, which is similar to the embodiment shown in FIG. 4B, the detecting circuit also includes a comparing unit 750. The comparing unit 750 outputs a comparing result from the output end in accordance with the first power source V1 and the reference power source V_{ref}. In other words, the comparing unit 750 compares the magnitude of the first power source V1 and the reference power source V_{ref}. If the first power source V1 is larger than the reference power source V_{ref}, the first power source V1 is sufficient to be a power source. Therefore, the detecting circuit 705 inputs the controlling signal Sc in accordance with the comparing result into the switch 703 to control the switch 703 conducting to the first power source V1. FIG. 5B is also a simplified circuit diagram that the other electronic units of the circuit are not shown. In other embodiment, the detecting circuit 705 may further includes a memory unit storing a predetermined value. The comparing unit compares the first power source V1 with the predetermined values. Similar, the detecting circuit 705 controls the switch 703 to conduct the first power source or the second power source in accordance with the control signal obtained by the comparing result.

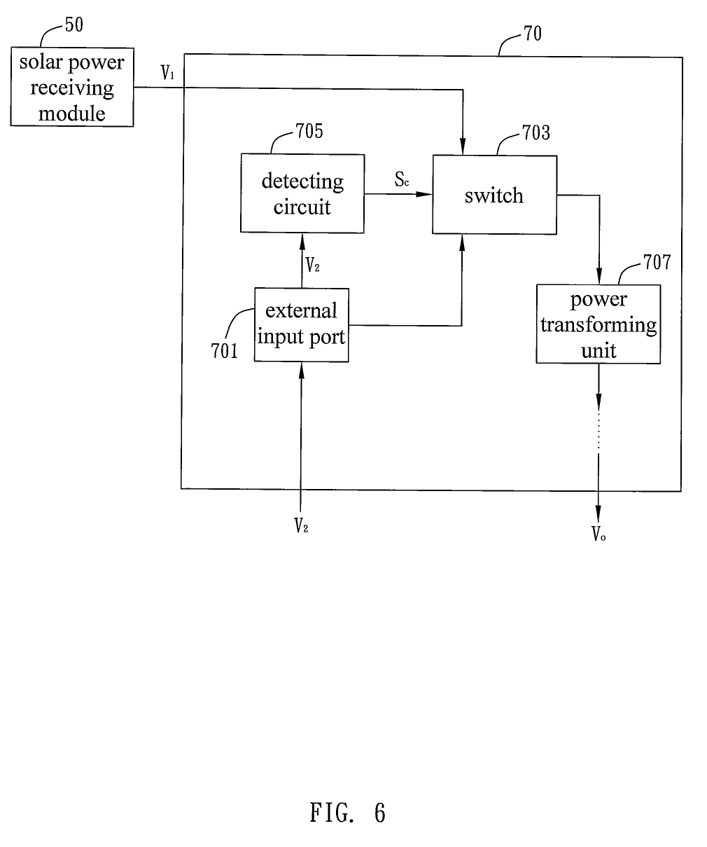

FIG. 6 shows anther embodiment circuit diagram of a power transformer 70. The detecting circuit 705 of the power transformer 70 electronically couples to the switch 703 and the second power source V2, rather than couples to the first power source V1. The detecting circuit 705 connects to a reference power source V_{ref}, wherein the detecting circuit 705 determines connecting the first power source V1 or the second power source V2 in accordance with the values of the second power source V2 and the reference power source V_{ref}.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A holding device with charging function for connecting an electronic device with an object, comprising:
a holder having a clamping part and a connecting part, wherein the connecting part is for connecting to the object;
a solar power receiving module disposed on the holder for receiving and transforming solar power to a first power source; and
a power transformer having an input port which is provided for electrically coupling to a second power source, the power transformer is coupled to the solar power receiving module, wherein the power transformer selectively transforms one of the first power source and the second power source to an output voltage.

2. The holding device of claim 1, wherein the power transformer includes:
a switch electrically coupled to the first power source and the second power source, wherein the switch selectively conducts to one of the first power source and the second power source; and
a detecting circuit electrically coupled to the switch, the first power source and the second power source for detecting voltage levels of the first power source and the second power source, wherein the detecting circuit outputs a controlling signal inducing the switch selectively conducting the first power source and the second power source in accordance with the voltage levels.

3. The holding device of claim 2, wherein the detecting circuit includes a comparing unit electrically coupled to the first power source and the second power source and outputting a comparing result in accordance with the first power source and the second power source, wherein the controlling signal inducing the switch selectively conducting the first power source and the second power source in accordance with the comparing result.

4. The holding device of claim 3, wherein the detecting circuit further includes a decision unit outputting the controlling signal in accordance with the comparing result and a logical operation.

5. The holding device of claim 2, wherein the detecting circuit includes a comparing unit having two input ends and an output end, the first power source and the second power source are respectively coupled to the input ends for obtaining a comparing result to output from the output end, wherein the controlling signal inducing the switch selectively conducting the first power source and the second power source in accordance with the comparing result.

6. The holding device of claim 1, wherein the power transformer includes:
a switch electrically coupled to the first power source and the second power source, wherein the switch selectively conducts to the first power source and the second power source; and
a detecting circuit electrically coupled to the switch and the first power source for detecting voltage levels of the first power source, wherein the detecting circuit outputs a controlling signal inducing the switch selectively conducting the first power source and the second power source in accordance with the voltage levels.

7. The holding device of claim 6, wherein the detecting circuit includes:
a comparing unit having two input ends and an output end, wherein one input end is coupled to the first power source; and
a reference power source coupled to the other input end of the comparing unit, wherein the output end obtains a comparing result in accordance with the values of the two input ends, the controlling signal induces the switch selectively conducting the first power source and the second power source in accordance with the comparing result.

8. The holding device of claim 6, wherein the detecting circuit includes:
a memory unit storing a predetermined value; and
a comparing unit obtaining a comparing result by comparing the first power source with the predetermined value, wherein the controlling signal inducing the switch selectively conducting the first power source and the second power source in accordance with the comparing result.

9. The holding device of claim 1, the power transformer includes:
a switch electrically coupled to the first power source and the second power source, wherein the switch selectively conducts to one of the first power source and the second power source; and
a detecting circuit electrically coupled to the switch and the second power source for detecting voltage levels of the second power source, wherein the detecting circuit outputs a controlling signal inducing the switch selectively conducting the first power source and the second power source in accordance with the voltage levels.

10. The holding device of claim 6, wherein the detecting circuit includes:
a comparing unit having two input ends and an output end, wherein one input end is coupled to the second power source; and
a reference power source coupled to the other input end of the comparing unit, wherein the output end obtains a comparing result in accordance with the values of the two input ends, the controlling signal induces the switch selectively conducting the first power source and the second power source in accordance with the comparing result.

11. The holding device of claim 1, wherein the power transformer further includes a power transforming unit selectively transforming the conducted first power source and the second power source to the output voltage.

12. The holding device of claim 11, wherein the power transformer has an external output port electrically coupled to the electronic device, wherein the output voltage is output through the external output port to the electric device.

13. The holding device of claim 1, wherein the holder has an external output port electrically coupled to the power transformer and the electronic device, wherein the output voltage is output through the external output port to the electric device.
